(19) United States
(12) Patent Application Publication
(10) Pub. No.: US 2023/0361966 A1
(43) Pub. Date: Nov. 9, 2023

(54) MONITORING PERIODIC REFERENCE SIGNALS

(71) Applicant: Lenovo (Singapore) Pte. Ltd., New Tech Park (SG)

(72) Inventors: Ankit Bhamri, Rödermark (DE); Karthikeyan Ganesan, Kronberg im Taunus (DE); Ali Ramadan Ali, Kronberg im Taunus (DE); Alexander Johann Maria Golitschek Edler von Elbwart, Darmstadt (DE); Vijay Nangia, Woodridge, IL (US)

(21) Appl. No.: 18/245,208

(22) PCT Filed: Sep. 14, 2021
(86) PCT No.: PCT/IB2021/058326

§ 371 Date: Mar. 14, 2023

Related U.S. Application Data
(60) Provisional application No. 63/078,018, filed on Sep. 14, 2020.

(51) Int. Cl. H04L 5/00; H04B 7/08

(52) U.S. Cl. CPC H04L 5/0051; H04B 7/088

(57) ABSTRACT

Apparatuses, methods, and systems are disclosed for monitoring periodic reference signals. One method includes detecting, at a device, for reception of a periodic downlink reference signal from at least a first beam, a number of consecutive occurrences of: an interference level being greater than an interference level threshold; a listen-before-talk failure; or a combination thereof. In some embodiments, the method includes determining whether the number of consecutive occurrences is greater than a predetermined threshold. In certain embodiments, the method includes, in response to the number of consecutive occurrences being greater than the predetermined threshold: monitoring to receive the periodic downlink reference signal from a second beam; terminating the monitoring for the reception of the downlink reference signal from at least the first beam for a time period; or a combination thereof.

### CROSS-REFERENCE TO RELATED APPLICATIONS

This application claims priority to U.S. Patent Application Ser. No. 63/078,018 entitled “APPARATUSES, METHODS, AND SYSTEMS FOR PERIODIC REFERENCE SIGNAL TRANSMISSION WITH DIRECTIONAL LBT” and filed on Sep. 14, 2020 for Ankit Bhamri, which is incorporated herein by reference in its entirety.

### FIELD

The subject matter disclosed herein relates generally to wireless communications and more particularly relates to monitoring periodic reference signals.

### BACKGROUND

In certain wireless communications networks, an LBT failure may occur and/or an interference level may be high. In such configurations, communications may be inhibited.

### BRIEF SUMMARY

Methods for monitoring periodic reference signals are disclosed. Apparatuses and systems also perform the functions of the methods. One embodiment of a method includes detecting, at a device, for reception of a periodic downlink reference signal from at least a first beam, a number of consecutive occurrences of: an interference level being greater than an interference level threshold; a listen-before-talk failure; or a combination thereof. In some embodiments, the method includes determining whether the number of consecutive occurrences is greater than a predetermined threshold. In certain embodiments, the method includes, in response to the number of consecutive occurrences being greater than the predetermined threshold: monitoring to receive the periodic downlink reference signal from a second beam; terminating the monitoring for the reception of the downlink reference signal from at least the first beam for a time period; or a combination thereof.

One apparatus for monitoring periodic reference signals includes a device. In some embodiments, the apparatus includes a processor that: detects, for reception of a periodic downlink reference signal from at least a first beam, a number of consecutive occurrences of: an interference level being greater than an interference level threshold; a listen-before-talk failure; or a combination thereof; determines whether the number of consecutive occurrences is greater than a predetermined threshold; and, in response to the number of consecutive occurrences being greater than the predetermined threshold: monitors to receive the periodic downlink reference signal from a second beam; terminates the monitoring for the reception of the downlink reference signal from at least the first beam for a time period; or a combination thereof.

Another embodiment of a method for monitoring periodic reference signals includes detecting, at a base station, for transmission of a downlink reference signal from at least a first beam, a number of consecutive occurrences of: an interference level being greater than an interference level threshold; a listen-before-talk failure; or a combination thereof. In some embodiments, the method includes determining whether the number of consecutive occurrences is greater than a predetermined threshold. In certain embodiments, the method includes, in response to the number of consecutive occurrences being greater than the predetermined threshold: transmitting the downlink reference signal from a second beam; inhibiting transmission of the downlink reference signal from at least the first beam for a time period; or a combination thereof.

Another apparatus for monitoring periodic reference signals includes a base station. In some embodiments, the apparatus includes a processor that: detects, for transmission of a downlink reference signal from at least a first beam, a number of consecutive occurrences of: an interference level being greater than an interference level threshold; a listen-before-talk failure; or a combination thereof; and determines whether the number of consecutive occurrences is greater than a predetermined threshold. In various embodiments, the apparatus includes a transmitter that, in response to the number of consecutive occurrences being greater than the predetermined threshold: transmits the downlink reference signal from a second beam; inhibits transmission of the downlink reference signal from at least the first beam for a time period; or a combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for monitoring periodic reference signals;

FIG. 2 is a schematic block diagram illustrating one embodiment of an apparatus that may be used for monitoring periodic reference signals;

FIG. 3 is a schematic block diagram illustrating one embodiment of an apparatus that may be used for monitoring periodic reference signals;

FIG. 4 is a schematic block diagram illustrating one embodiment of a system having periodic CSI-RS transmissions missed due to LBT failure;

FIG. 5 is a schematic block diagram illustrating one embodiment of a system that performs autonomous beam switching for periodic CSI-RS transmissions missed due to LBT failure;

FIG. 6 is a schematic block diagram illustrating one embodiment of a system that performs autonomous deactivation of a periodic CSI-RS transmission due to LBT failure;

FIG. 7 is a schematic block diagram illustrating one embodiment of a system that has resource specific LBT failure counters;

FIG. 8 is a schematic block diagram illustrating one embodiment of a system that has a resource set specific LBT failure counter;

FIG. 9 is a schematic block diagram illustrating one embodiment of a system that transmits on different beam resources;

FIG. 10 is a flow chart diagram illustrating one embodiment of a method for monitoring periodic reference signals; and

FIG. 11 is a flow chart diagram illustrating another embodiment of a method for monitoring periodic reference signals.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

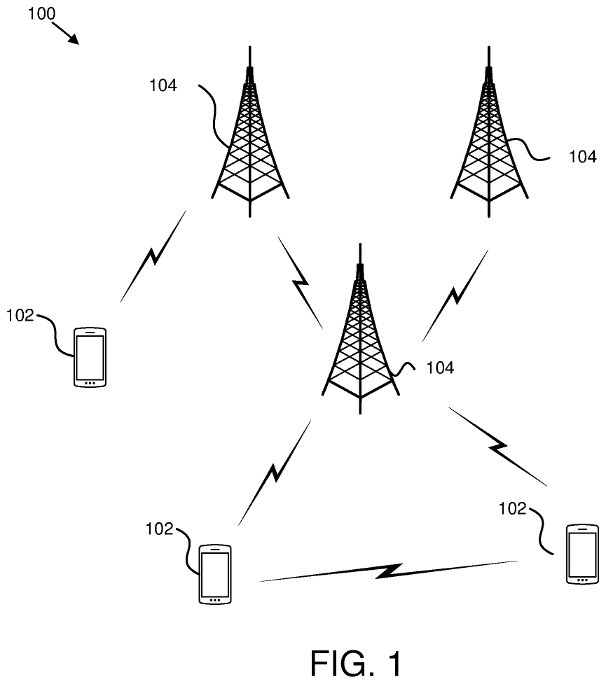

FIG. 1 depicts an embodiment of a wireless communication system 100 for monitoring periodic reference signals. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme.

More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may detect for reception of a periodic downlink reference signal from at least a first beam, a number of consecutive occurrences of: an interference level being greater than an interference level threshold; a listen-before-talk failure; or a combination thereof. In some embodiments, the remote unit 102 may determine whether the number of consecutive occurrences is greater than a predetermined threshold. In certain embodiments, the remote unit 102 may, in response to the number of consecutive occurrences being greater than the predetermined threshold: monitor to receive the periodic downlink reference signal from a second beam; terminate the monitoring for the reception of the downlink reference signal from at least the first beam for a time period; or a combination thereof. Accordingly, the remote unit 102 may be used for monitoring periodic reference signals.

In certain embodiments, a network unit 104 may detect for transmission of a downlink reference signal from at least a first beam, a number of consecutive occurrences of: an interference level being greater than an interference level threshold; a listen-before-talk failure; or a combination thereof. In some embodiments, the network unit 104 may determine whether the number of consecutive occurrences is greater than a predetermined threshold. In certain embodiments, the network unit 104 may, in response to the number of consecutive occurrences being greater than the predetermined threshold: transmit the downlink reference signal from a second beam; inhibit transmission of the downlink reference signal from at least the first beam for a time period; or a combination thereof. Accordingly, the network unit 104 may be used for monitoring periodic reference signals.

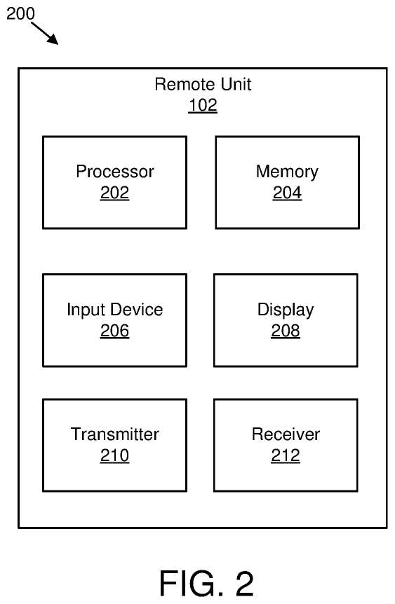

FIG. 2 depicts one embodiment of an apparatus 200 that may be used for monitoring periodic reference signals. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202: detects, for reception of a periodic downlink reference signal from at least a first beam, a number of consecutive occurrences of: an interference level being greater than an interference level threshold; a listen-before-talk failure; or a combination thereof; determines whether the number of consecutive occurrences is greater than a predetermined threshold; and, in response to the number of consecutive occurrences being greater than the predetermined threshold: monitors to receive the periodic downlink reference signal from a second beam; terminates the monitoring for the reception of the downlink reference signal from at least the first beam for a time period; or a combination thereof.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

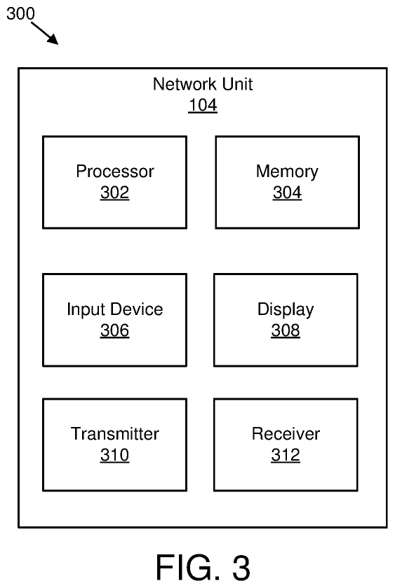

FIG. 3 depicts one embodiment of an apparatus 300 that may be used for monitoring periodic reference signals. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302: detects, for transmission of a downlink reference signal from at least a first beam, a number of consecutive occurrences of: an interference level being greater than an interference level threshold; a listen-before-talk failure; or a combination thereof; and determines whether the number of consecutive occurrences is greater than a predetermined threshold. In various embodiments, the transmitter 310, in response to the number of consecutive occurrences being greater than the predetermined threshold: transmits the downlink reference signal from a second beam; inhibits transmission of the downlink reference signal from at least the first beam for a time period; or a combination thereof.

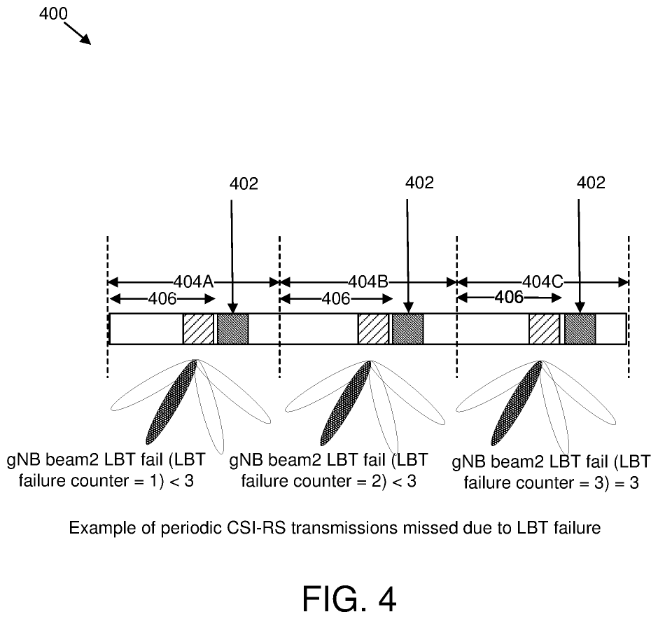

In certain embodiments, there may be periodic and/or semi-persistent transmission of reference signals for a beam-based listen before-talk (“LBT”) based channel access mechanism in an unlicensed spectrum. In such embodiments, in the LBT based channel access mechanism, to transmit any periodic reference signals, a transmitter may be required to sense a channel for potential on-going transmissions from nodes or other systems such as WiFi and/or WiGig (e.g., in 60 GHz band) in the unlicensed spectrum. If the transmitter detects interference above a certain threshold, then the channel is not clear and an LBT failure at the transmitter is assumed. Because of the possibility of LBT failure, periodic reference signals (“RSs”) such as a channel state information (“CSI”) RS (“CSI-RS”) cannot be transmitted. Moreover, for new radio (“NR”) beam-management in frequency range 2 (“FR2”) and beyond, periodic RSs, such as periodic CSI-RS, may be one of the main sources of RSs for establishing beam direction for other reference signals such as CSI-RS itself, tracking reference signal (“TRS”), demodulation (“DM”) RS (“DM-RS”) for a physical downlink control channel (“PDCCH”), DM-RS for a physical downlink shared channel (“PDSCH”), DM-RS for a physical uplink shared channel (“PUSCH”), a sounding reference signal (“SRS”), as shown in FIG. 4. Furthermore, beam failure detection RSs and candidate RSs for new beam identification in a defined beam failure recovery procedure may need to be periodic, and typically failure detection RSs may be periodic CSI-RS as being quasi-co-located (“QCL”) sources for the PDCCH monitoring in control resource sets (“CORESETs”).

In some embodiments, if a periodic RS is not able to be transmitted because of LBT failure, beam-management procedures may not be ensured, and this may result in frequent beam misalignment and consequently beam failure. Therefore, periodic RS transmission may be adapted based on directional LBT failures and a possibility of transmitting periodic RS on configured resources may be increased.

FIG. 4 is a schematic block diagram illustrating one embodiment of a system 400 having periodic CSI-RS transmissions missed due to LBT failure. Due to LBT failure, a periodic CSI (“P-CSI”) 402 is not transmitted. The illustrated timing includes a first CSI period 404A, a second CSI period 404B, and a third CSI period 404C, with each CSI period having a timing offset 406 from the start of the CSI period to the scheduled location for the P-CSI. Moreover, as illustrated, gNB beam2 has an LBT failure for 3 consecutive times as shown by the LBT failure counter.

It should be noted that, as used herein: 1) although certain embodiments are described in terms of a periodic downlink (“DL”) RS where a transmission is by a gNB, similar embodiments may apply to a periodic uplink (“UL”) RS or a periodic sidelink (“SL”) RS and/or for transmissions by a UE; 2) a transmit (“TX”) spatial filter and a TX beam may be interchangeably used, similarly a receiver (“RX”) spatial filter and a RX beam may be interchangeably used; 3) an indicated quasi-co-location (“QCL”) Type-D assumption or transmission configuration indicator (“TCI”) state for a UE may be interchangeably used; 4) although certain embodiments are discusses in terms of an LBT failure counter, the counter may be applicable to counting a number of detections with an interference measurement level above a threshold (e.g., interference detection counter) as well as for no LBT based unlicensed access; and/or 5) a counter may be used assuming an initial value of 0, being incremented under specific conditions, and causing an action to be executed upon reaching a value of N; however, it may be understood that the counter may be assumed having an initial value of N, being decremented under specific conditions, and causing an action to be executed upon reaching a value of 0.

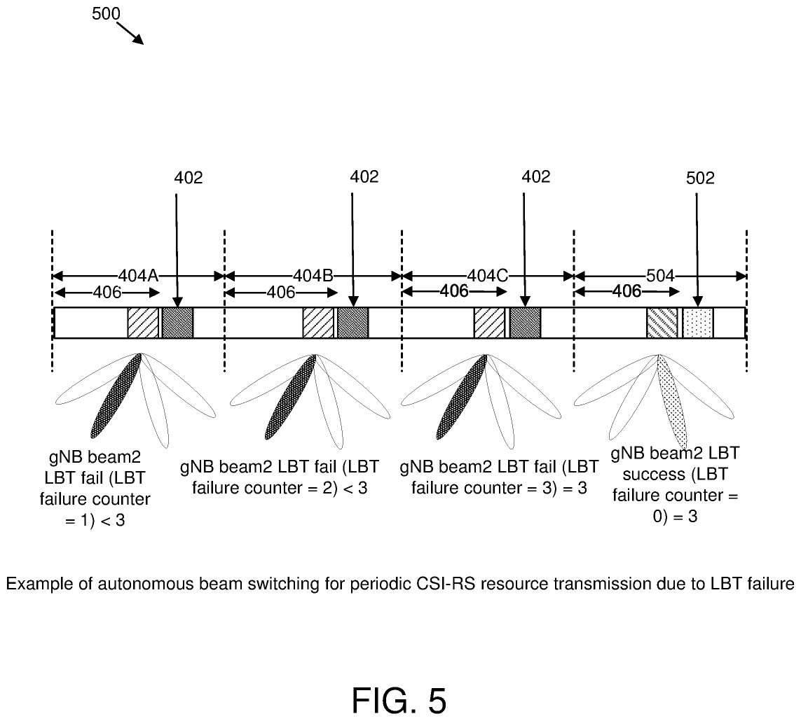

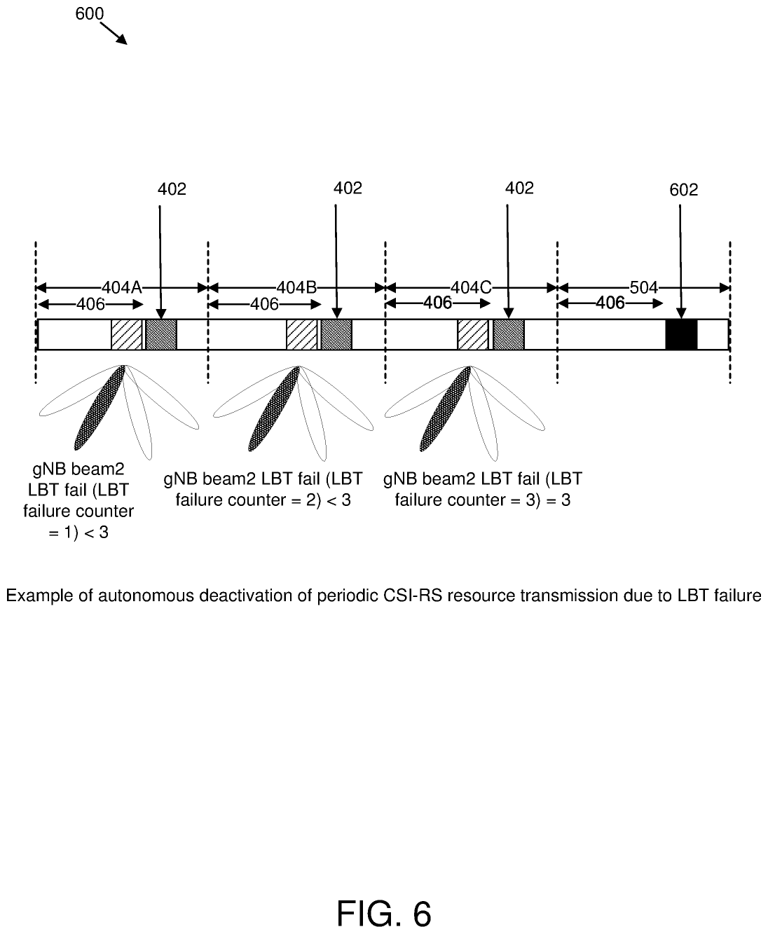

In various embodiments, a transmission of periodic RS may be autonomously adapted based on a continuous, a successive, and/or a consecutive number of detections having an interference level above a certain threshold from other systems such as Wifi and/or WiGig and/or a number of continuous, successive, and/or consecutive LBT failures, where the autonomous adaptation is done by: 1) for periodic DL RS transmission on a single periodic RS resource, if the gNB encounters one or more continuous instances where the interference level is above a threshold and/or a number of continuous LBT failures in a specific beam direction is above a certain threshold (e.g., prior to the periodic RS resource transmission), then the gNB may autonomously switch the TX beam direction (e.g., change TX spatial filter) to a different beam for transmission of the periodic DL RS on that resource and the UE may be expected to switch its RX spatial filter (e.g., RX beam) (e.g., to the RX spatial filter configuration the UE has used for reception of signals and/or channel associated with the changed TX spatial filter) without any radio resource configuration (“RRC”) or medium access control (“MAC”) control element (“CE”) (“MAC-CE”) configuration and/or reconfiguration. RRC or MAC-CE configuration signaling transmitted from II) a gNB to a UE may contain details of a switching pattern for a spatial filter configuration (e.g., FIG. 5); and/or 2) for periodic DL RS transmission on a single periodic RS resource, if the gNB encounters one or more continuous instances where the interference level is above a threshold and/or a number of continuous LBT failures in a specific beam direction is above a certain configured threshold (e.g., prior to the periodic RS resource transmission), then the gNB may implicitly or explicitly deactivate (or skip) the transmission of that periodic RS on that specific resource for the following transmission occasions (e.g., releasing and/or skipping those specific RS resources) and the UE is not expected to monitor the periodic RS transmission on the corresponding released and/or skipped resources (e.g., FIG. 6).

FIG. 5 is a schematic block diagram illustrating one embodiment of a system 500 that performs autonomous beam switching for periodic CSI-RS transmissions missed due to LBT failure. Due to LBT failure, a P-CSI 402 is not transmitted until a time 502 after which the gNB autonomously switches transmission beams. The illustrated timing includes a first CSI period 404A, a second CSI period 404B, a third CSI period 404C, and a fourth CSI period 504, with each CSI period having a timing offset 406 from the start of the CSI period to the scheduled location for the P-CSI. Moreover, as illustrated, gNB beam2 has an LBT failure for 3 consecutive times as shown by the LBT failure counter, then the gNB autonomously switches transmission to a different beam.

FIG. 6 is a schematic block diagram illustrating one embodiment of a system 600 that performs autonomous deactivation of a periodic CSI-RS transmission due to LBT failure. Due to LBT failure, a P-CSI 402 is not transmitted until a time 602 after which the gNB autonomously deactivates transmission of the P-CSI. The illustrated timing includes a first CSI period 404A, a second CSI period 404B, a third CSI period 404C, and a fourth CSI period 504, with each CSI period having a timing offset 406 from the start of the CSI period to the scheduled location for the P-CSI. Moreover, as illustrated, gNB beam2 has an LBT failure for 3 consecutive times as shown by the LBT failure counter, then the gNB autonomously deactivates transmission of the P-CSI.

In certain embodiments, a UE may be configured with multiple carriers (e.g., contiguous carrier aggregation (“CA”)), LBT bandwidths, and/or available RB sets. The UE may be configured with a first periodic RS resource set for a first carrier, LBT bandwidth, and/or available RB set, a1, and a second periodic RS resource set for a second carrier, LBT bandwidth, and/or available RB set, a2. The periodic RS resources time symbol locations and associated QCL-Type-D assumption and/or TCI-states for the first periodic RS resource set is the same as that for the second periodic RS resource set. In one example, a common periodic RS resource set configuration may be configured for a1 and a2. Thus, a same TX beam direction (e.g., TX spatial filter) may be used for periodic RS transmission on the RS resource on a1 and a2. The UE may not receive a periodic RS in a first transmission occasion (e.g., periodic RS resource) on a1 (e.g., due to an interference level being above a threshold and/or LBT failure) but may receive a periodic RS in the first transmission occasion on a2. In this case, the UE may assume the measurements or parameters estimated based on the periodic RS on a2 may also be used and/or may be valid on a1 corresponding to the periodic RS that the UE failed to receive in the first transmission occasion on a1. Thus, the UE does not increment the LBT failure counter (and can reset the counter as the UE has received at least one periodic RS in the first transmission occasion). The UE only increments the counter if the periodic RS on a transmission occasion is not received on both a1 and a2.

In some embodiments, a UE increments a beam failure counter by 1 if the UE reaches a maximum configured and/or preconfigured LBT failure: 1) in all of the m number of QCL type-D (e.g., beam direction) assumptions or at least m number of TCI states for each of the periodic RS resource (e.g., for all periodic RS resources configured for beam failure detection); 2) in all of the configured beam specific RS (e.g., for all periodic RS resources configured for beam failure detection); and/or 3) if only one QCL assumption and/or TCI state is configured by RRC signaling, if an LBT failure counter reaches a maximum configured and/or preconfigured value.

In various embodiments described herein, benefits may include increasing the possibility of periodic RS transmission and/or avoiding periodic resource configuration in specific beam directions if a frequent LBT failure is encountered.

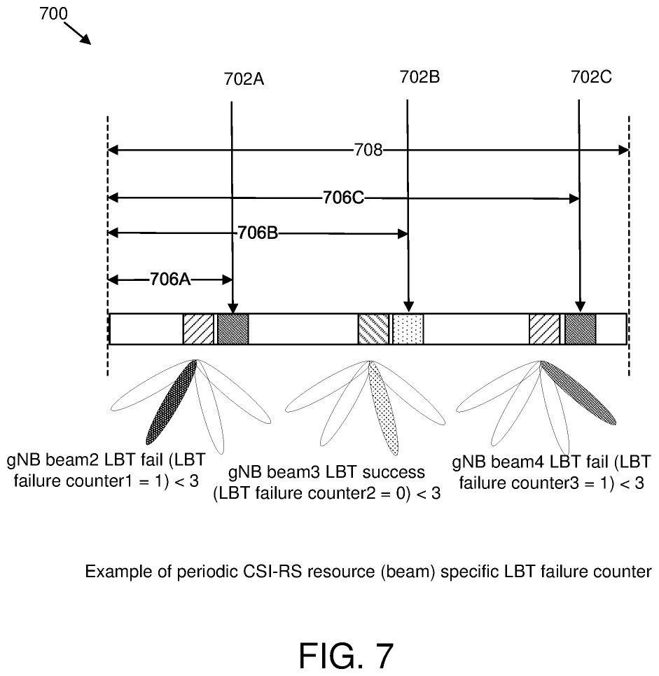

In an embodiment 1-1, a UE is configured with a separate LBT failure counter for each periodic RS resource within a RS resource set for transmission from a gNB to a UE if the gNB is expected to use separate, different, and/or not all the same TX spatial filters for each resource and the UE applies the QCL type-D assumption or TCI state configured and/or indicated for receiving periodic RSs on each of the resources. For example, if there are 8 periodic RS resources (e.g., RS may be a CSI-RS or synchronization signal block (“SSB”)) configured with specific beams, then 8 LBT failure counters are associated with each of the periodic RS resources, as shown in FIG. 7. In certain embodiments, a UE procedure for maintaining the LBT failure counter value includes: 1) a LBT failure counter for each periodic RS resource (e.g., with separate beam, spatial TX filter, QCL type-D, and/or TCI state) starts with value 0 if the periodic RS resources are configured by RRC and/or MAC-CE signaling by a network; 2) the UE is expected to receive the periodic RS on the configured resource with QCL type-D assumption or TCI state, the UE increases the counter value by 1 associated with the corresponding periodic RS resource (e.g., corresponding beam) if the UE does not receive the corresponding periodic RS due to LBT failures (e.g., correlation of the received signal on the corresponding periodic RS resource with a replica of the transmitted periodic RS is below a threshold, or detected energy of the received signal on the corresponding periodic RS resource is below a threshold; the threshold can be based on one or more the received signal power, interference power etc.)—in one example, the threshold is selected such that the mis-detection and/or discontinuous transmission (“DTX”) detection rates performance requirements are met—in another example, the UE can increase the LBT failure counter by for a resource associated with specific QCL type-D assumption or TCI state if any other signal or channel is not received (e.g., below certain threshold) using the same QCL type-D assumption or TCI state—therefore, the counter value is affected (e.g., increased and/or restarted) by not only a periodic RS success or failure in a specific beam, but also by other channels and/or signals in that specific beam; 3) a counter value associated with a periodic RS resource is reset to 0 if a) the UE receives the periodic RS on that RS resource; orb) the UE reaches the counter value at a configured and/or preconfigured threshold value N and performs an associated action; 4) in a first option, the UE releases a beam specific RS resource or does not monitor the beam specific RS resource if LBT failure reaches the configured and/or preconfigured threshold for the corresponding beam for certain embodiments; and/or 5) in a second option, the UE increments the beam failure counter by 1 if the UE reaches a maximum configured and/or preconfigured LBT failure in all of the configured beam specific RS (e.g., for all periodic RS resources configured for beam failure detection).

FIG. 7 is a schematic block diagram illustrating one embodiment of a system 700 that has resource (e.g., beam) specific LBT failure counters. A first P-CSI 702A, a second P-CSI 702B, and a third P-CSI 702C are not transmitted. The illustrated timing includes timing offsets 706A, 706B, and 706C from the start of a CSI period 708 to a corresponding scheduled location for a P-CSI. Moreover, as illustrated, gNB beam2 has an LBT failure, gNB beam3 has an LBT success, and gNB beam4 has an LBT failure. A separate beam failure counter for each beam is incremented as an LBT failure occurs for the corresponding beam.

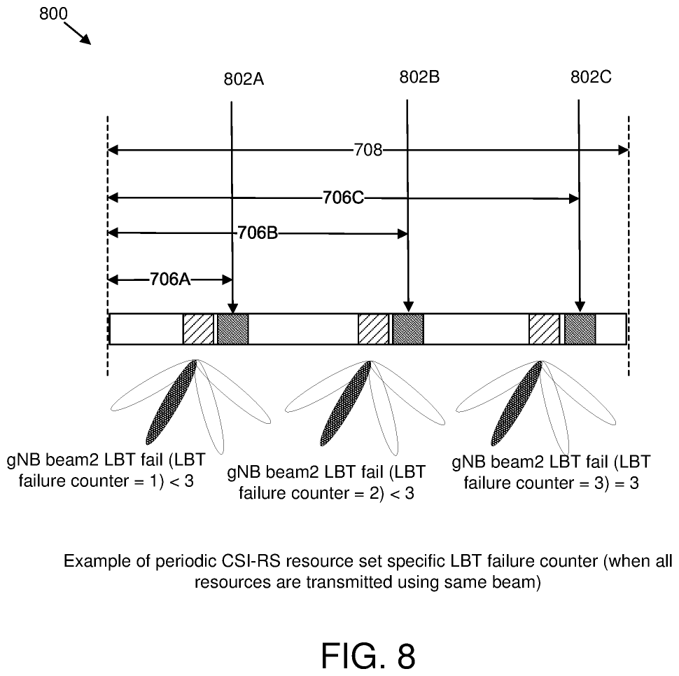

In an embodiment 1-2, a UE is configured with a single LBT failure counter associated with a plurality of the periodic RS resources within an RS resource set, where the plurality of the periodic RS resources may include all the periodic RS resources within the RS resource set. The UE may assume that a gNB is using same TX spatial filter for periodic RS transmission on different RS resources within the set (e.g., if a non-zero power (“NZP”) CSI-RS resource set is configured with repetition=“ON” in an RRC configuration). For example, if there are 8 periodic CSI-RS resources configured and RRC parameter repetition=“ON”, then the same (e.g., one) LBT failure counter is associated with all the periodic RS resources, as shown in FIG. 8. In some embodiments, a UE procedure for maintaining the LBT failure counter value includes: 1) an LBT failure counter associated with an entire RS resource set starts with value 0 if the periodic RS resources are configured by RRC and/or MAC-CE signaling by a network; 2) if the UE is expected to receive the periodic RS on any of the configured resources within a RS set, but did not receive the periodic RS, then the UE increases the counter value by 1—in one example, the counter value is adjusted once per RS resource set with the counter value incremented only if a periodic RS is not received in all of the configured resources; 3) a counter value is reset to 0 if: a) the UE receives the periodic RS on any of the configured resources within a resource set; or b) the UE reaches the counter value at a configured and/or preconfigured threshold value N and performs an associated action; 4) in a first option, the UE may assume a TX spatial filter change and/or update (e.g., corresponding to a second QCL type-D assumption and/or TCI state) and autonomously switch the RX spatial filter (e.g., if two QCL assumptions and/or TCI states are configured by RRC signaling) if the LBT failure counter reaches a maximum configured and/or preconfigured value; and/or 5) in a second option, the UE may increment the beam failure counter by 1 (e.g., if only one QCL assumption and/or TCI state is configured by RRC signaling) if the LBT failure counter reaches a maximum configured and/or preconfigured value.

FIG. 8 is a schematic block diagram illustrating one embodiment of a system 800 that has a resource set specific LBT failure counter (e.g., if all resources are transmitted using the same beam). A first P-CSI 802A, a second P-CSI 802B, and a third P-CSI 802C are not transmitted. The illustrated timing includes timing offsets 706A, 706B, and 706C from the start of a CSI period 708 to a corresponding scheduled location for a P-CSI. Moreover, as illustrated, gNB beam2 has an LBT failure for 3 consecutive times as shown by the LBT failure counter, with each failure on the same beam in the same resource set. A resource set specific beam failure counter for the resource set is incremented as an LBT failure occurs for the corresponding resource set.

In an embodiment 1-3, a gNB indicates whether the last X periodic RS transmissions before the present Yth periodic RS transmission encountered LBT failure or success by scrambling a sequence of length X bits by the RS sequence. For example, if a bit sequence of length 3 with 110 is to be scrambled, then this may imply that (Y-1)st, (Y-2)th, and (Y-3)rd periodic RS transmission had LBT failure, LBT failure, and LBT success, respectively. If the UE receives the scrambled periodic RS sequence, the UE may decode the received RS with all possible combinations for a bit length 3 sequence and based on the detection threshold, the UE decides which is the correct bit sequence transmitted by the gNB. If the decoded bit sequence is exactly the same as a UE hypothesis, then no update may be done to the on-going LBT counter. If the decoded bit sequence is different from the UE hypothesis, then the on-going LBT counter may be updated by the UE according to either embodiment 1-1 or embodiment 1-2. In one example, only 1 bit length sequence is scrambled if the LBT status is only for previous CSI periodic transmissions indicated by the gNB.

In an embodiment 2-1, a UE is configured with at least two QCL type-D (e.g., RX beam direction) assumptions or at least two TCI states for each periodic RS resource and an LBT failure counter is associated with each periodic RS resource (e.g., as described in embodiment 1-1) using RRC signaling if the UE assumes that the gNB transmits each periodic RS with its associated first spatial TX filter (e.g., corresponding to the first QCL type-D and/or TCI-state) until the associated LBT failure counter equals a configured and/or preconfigured threshold N. Once the UE reaches the counter value of N, then the UE autonomously switches the RX spatial filter and assumes that the gNB transmits each periodic RS with its associated second TX spatial filter (e.g., corresponding to the second QCL type-D and/or TCI-state) and the UE expects to receive it with a second QCL type-D assumption or a second TCI state.

In one example of embodiment 2-1, if the UE is configured with an m number of QCL type-D (e.g., beam direction) assumptions or at least an m number of TCI states for each of the periodic RS resources and a configured value of an LBT failure counter associated with each periodic RS resource, where the UE assumes that the gNB transmits each periodic RS with its associated first TX spatial filter until the associated LBT failure counter equals the configured and/or preconfigured threshold N. Once the UE reaches the counter value of N, then the UE assumes the gNB transmits each periodic RS with its associated second TX spatial filter. Once the UE reaches the counter value of 2*N, then the UE assumes that the gNB transmits each periodic RS with its associated third TX spatial filter and so on until m=M QCL t e-D assumption of m=M TCI state is reached, where M is the maximum number of configured TCI states. In some embodiments, multiple LBT failure counters are configured for each of the periodic RSs such that each counter is associated with each of the QCL type-D assumption or TCI states.

In certain examples of embodiment 2-1, a counter value associated with a periodic RS resource is reset to 0 if a) the UE receives the periodic RS on that RS resource with any of the configured QCL type-D assumptions; orb) the UE reaches the counter value of m*N.

In some examples of embodiment 201, as one option, the UE increments the beam failure counter by 1 if the UE reaches a maximum configured and/or preconfigured LBT failure in all of the m number of QCL type-D (e.g., beam direction) assumptions or at least m number of TCI states for each of the periodic RS resources (e.g., for all periodic RS resources configured for beam failure detection).

In an embodiment 2-2, a UE assumes that the a gNB transmits periodic RSs on each of the resources within a resource set using the same first TX spatial filter (e.g., if NZP CSI-RS resource set is configured with repetition=“ON” in an RRC configuration) and if the UE is expected to receive the periodic RS on any of the resource within the resource set, but did not receive it, then the UE increases the LBT failure counter by one. If the LBT failure counter reaches a configured and/or preconfigured threshold N, then the UE assumes that the gNB is transmitting periodic RSs on each of the resources within the resource set using the second TX spatial filter (e.g., TX beam).

In an embodiment 2-3, a UE is configured with at least two QCL type-D (beam direction) assumptions or at least two TCI states for each of the periodic RS resources and an LBT failure counter associated with each periodic RS resource (e.g., as described in embodiment 1-1). In such embodiments, the UE is configured with at least two time-offsets for shifting the periodic RS resource by that offset within a period. A first transmission occasion for a periodic RS resource within a period may determined by the first time offset with respect to the beginning of period and there may be an additional second transmission occasion for the same periodic RS resource within the same period and whose position is determined based on the second time offset. For the first transmission occasion of a periodic RS resource within a period, a gNB performs LBT in the first TX spatial filter and, if the LBT is successful, then the gNB transmits the periodic RS and the UE expects to receive the transmission by using the first QCL type-D assumption or the first TCI state.

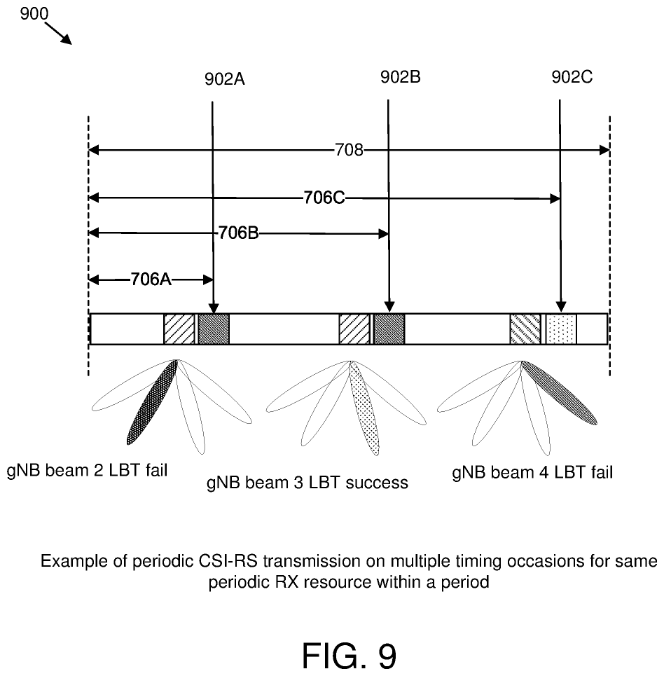

In such an embodiment, the UE does not expect to receive the same periodic RS resource in the second time offset within the same period. However, if the gNB has LBT failure in the first time occasion using the first time offset value within the same period, then the gNB performs LBT for the second time occasion (e.g., based on second time offset value) corresponding to the second TX spatial filter and the UE is expected to monitor the second transmission occasion using the second QCL type-D assumption or the second TCI state, as shown in FIG. 9. In one example, the same QCL type-D (e.g., beam direction) assumption or TCI state is used for each of the periodic RS resources providing multiple transmission occasions opportunities for transmitting the periodic RS with the same spatial TX filter within the same period.

FIG. 9 is a schematic block diagram illustrating one embodiment of a system 900 that transmits on different beam resources. A first P-CSI 902A, a second P-CSI 902B, and a third P-CSI 902C are not transmitted. The illustrated timing includes timing offsets 706A, 706B, and 706C from the start of a CSI period 708 to a corresponding scheduled location for a P-CSI. Moreover, as illustrated, gNB beam2 has an LBT failure, gNB beam 3 has an LBT success, and gNB beam 4 has an LBT failure.

In an embodiment 3-1, a UE is configured with an LBT failure counter that is associated with each of the periodic RS resources within a RS resource set, where the UE is expected to receive the periodic RS by using a single QCL type-D assumption or a single TCI state configured for the corresponding RS resource within the RS resource. If the LBT failure counter is increased (e.g., up on continuous LBT failure on a given RS resource associated with a specific beam) and reaches the configured and/or preconfigured threshold value, then the gNB may explicitly or implicitly deactivate and/or skip the transmission of that periodic RS on that specific resource for the following transmission occasions (e.g., releasing and/or skipping those specific RS resources). The UE is configured with a configured and/or a preconfigured threshold and the UE is not expected to monitor the periodic RS transmission after the configured and/or preconfigured threshold and may consider the corresponding resource as released and/or skipped.

In an embodiment 3-2, a UE is configured with a single LBT failure counter that is associated the periodic RS resource set, where the UE expects the gNB to use the same TX spatial filter (e.g., if an NZP CSI-RS resource set is configured with repetition=“ON” in the RRC configuration). If the LBT failure counter is increased (e.g., upon continuous LBT failure on any of the RS resources within the periodic RS resource set) and passes the configured and/or preconfigured threshold value, then the gNB may explicitly or implicitly deactivate and/or skip the transmission of all the periodic RSs on all the resources for the following transmission occasions (e.g., releasing and/or skipping all periodic RS resources for the given RS resource set).

The UE may be configured with a configured and/or preconfigured threshold and the UE does not expect to monitor the periodic RS transmission after the configured and/or preconfigured threshold and may consider the corresponding resource as released and/or skipped.

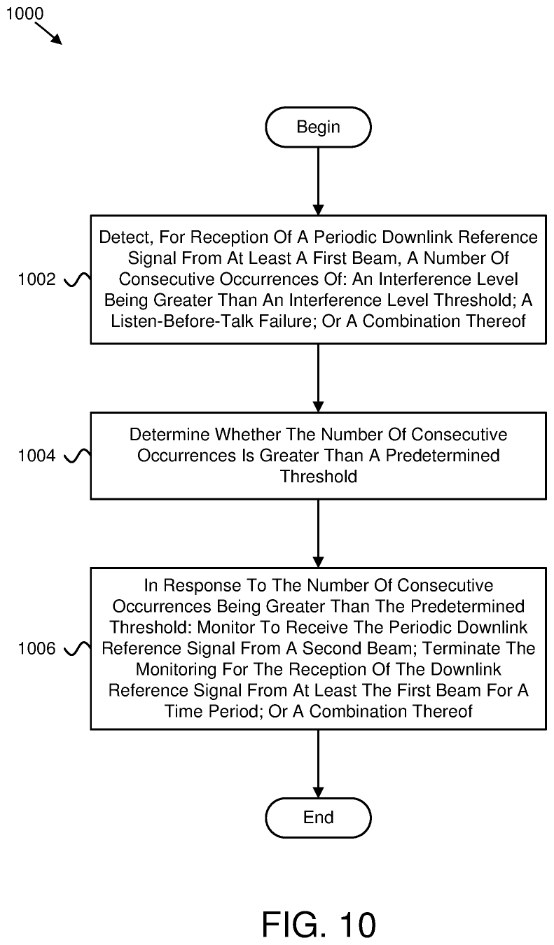

FIG. 10 is a flow chart diagram illustrating one embodiment of a method 1000 for monitoring periodic reference signals. In some embodiments, the method 1000 is performed by an apparatus, such as the remote unit 102. In certain embodiments, the method 1000 may be performed by a processor executing program code, for example, a microcontroller, a microprocessor, a CPU, a GPU, an auxiliary processing unit, a FPGA, or the like.

In various embodiments, the method 1000 includes detecting 1002 for reception of a periodic downlink reference signal from at least a first beam, a number of consecutive occurrences of: an interference level being greater than an interference level threshold; a listen-before-talk failure; or a combination thereof. In some embodiments, the method 1000 includes determining 1004 whether the number of consecutive occurrences is greater than a predetermined threshold. In certain embodiments, the method 1000 includes, in response to the number of consecutive occurrences being greater than the predetermined threshold: monitoring 1006 to receive the periodic downlink reference signal from a second beam; terminating the monitoring for the reception of the downlink reference signal from at least the first beam for a time period; or a combination thereof.

In certain embodiments, the reception of the periodic downlink reference signal from at least the first beam comprises reception of the downlink reference signal from the first beam using a single periodic reference signal resource. In some embodiments, the method 1000 further comprises receiving configuration information to indicate a switching pattern for a spatial filter configuration before detecting the number of consecutive occurrences. In various embodiments, in response to the number of consecutive occurrences being greater than the predetermined threshold, monitoring to receive the periodic downlink reference signal from the second beam, terminating the monitoring for the reception of the downlink reference signal from at least the first beam for the time period, or the combination thereof without receiving additional configuration information.

In one embodiment, the method 1000 further comprises incrementing a counter to track the number of consecutive occurrences. In certain embodiments, incrementing the counter comprises incrementing a separate counter for each periodic reference signal resource, for each beam, or a combination thereof. In some embodiments, the method 1000 further comprises resetting the separate counter in response to proper transmission on a corresponding periodic reference signal resource, a corresponding beam, or the combination thereof.

In various embodiments, the method 1000 further comprises resetting the separate counter in response to the separate counter reaching the predetermined threshold and a resulting action being performed. In one embodiment, the method 1000 further comprises receiving information indicating a value of a counter. In certain embodiments, the information indicating the value of the counter is scrambled.

In some embodiments, the predetermined threshold corresponds to a single periodic reference signal resource or a single beam. In various embodiments, the predetermined threshold corresponds to all periodic reference signal resources, all beams, or a combination thereof. In one embodiment, the first beam is quasi-co-located with the second beam.

In certain embodiments, the reception of the downlink reference signal on at least the first beam comprises reception of the downlink reference signal on a plurality of beams, and reception on the plurality of beams is offset in time from each other. In some embodiments, terminating the monitoring for the reception of the downlink reference signal from at least the first beam for the time period comprises terminating the monitoring for the reception of the downlink reference signal from at least the first beam for the time period without receiving an indication. In various embodiments, terminating the monitoring for the reception of the downlink reference signal from at least the first beam for the time period comprises receiving an indication, and the indication indicates that the reception of the downlink reference signal from at least the first beam is inhibited for the time period.

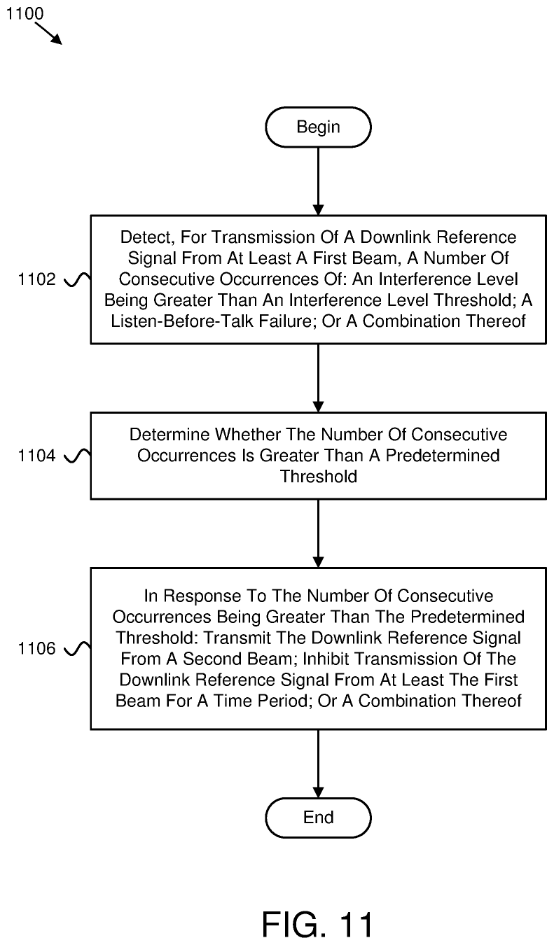

FIG. 11 is a flow chart diagram illustrating one embodiment of a method 1100 for monitoring periodic reference signals. In some embodiments, the method 1100 is performed by an apparatus, such as the network unit 104. In certain embodiments, the method 1100 may be performed by a processor executing program code, for example, a microcontroller, a microprocessor, a CPU, a GPU, an auxiliary processing unit, a FPGA, or the like.

In various embodiments, the method 1100 includes detecting 1102 for transmission of a downlink reference signal from at least a first beam, a number of consecutive occurrences of: an interference level being greater than an interference level threshold; a listen-before-talk failure; or a combination thereof. In some embodiments, the method 1100 includes determining 1104 whether the number of consecutive occurrences is greater than a predetermined threshold. In certain embodiments, the method 1100 includes, in response to the number of consecutive occurrences being greater than the predetermined threshold: transmitting 1106 the downlink reference signal from a second beam; inhibiting transmission of the downlink reference signal from at least the first beam for a time period; or a combination thereof.

In certain embodiments, the transmission of the downlink reference signal from at least the first beam comprises transmission of the downlink reference signal from the first beam using a single periodic reference signal resource. In some embodiments, the method 1100 further comprises transmitting configuration information to a user equipment to indicate a switching pattern for a spatial filter configuration before detecting the number of consecutive occurrences. In various embodiments, in response to the number of consecutive occurrences being greater than the predetermined threshold, the downlink reference signal is transmitted from the second beam, the downlink reference signal is inhibited from being transmitted from at least the first beam for the time period, or the combination thereof without transmitting additional configuration information to a user equipment.

In one embodiment, the method 1100 further comprises incrementing a counter to track the number of consecutive occurrences. In certain embodiments, incrementing the counter comprises incrementing a separate counter for each periodic reference signal resource, for each beam, or a combination thereof. In some embodiments, the method 1100 further comprises resetting the separate counter in response to proper transmission on a corresponding periodic reference signal resource, a corresponding beam, or the combination thereof.

In various embodiments, the method 1100 further comprises resetting the separate counter in response to the separate counter reaching the predetermined threshold and a resulting action being performed. In one embodiment, the method 1100 further comprises transmitting information indicating a value of the counter to a user equipment. In certain embodiments, the information indicating the value of the counter is scrambled.

In some embodiments, the predetermined threshold corresponds to a single periodic reference signal resource or a single beam. In various embodiments, the predetermined threshold corresponds to all periodic reference signal resources, all beams, or a combination thereof. In one embodiment, the first beam is quasi-co-located with the second beam.

In certain embodiments, the transmission of the downlink reference signal from at least the first beam comprises transmission of the downlink reference signal from a plurality of beams, and transmission from the plurality of beams are offset in time from each other. In some embodiments, inhibiting the transmission of the downlink reference signal from at least the first beam for the time period comprises inhibiting the transmission of the downlink reference signal from at least the first beam for the time period without sending an indication to a user equipment. In various embodiments, inhibiting the transmission of the downlink reference signal from at least the first beam for the time period comprises transmitting an indication to a user equipment, and the indication indicates that the transmission of the downlink reference signal from at least the first beam is inhibited for the time period.

In one embodiment, a method of a device comprises: detecting, for reception of a periodic downlink reference signal from at least a first beam, a number of consecutive occurrences of: an interference level being greater than an interference level threshold; a listen-before-talk failure; or a combination thereof; determining whether the number of consecutive occurrences is greater than a predetermined threshold; and, in response to the number of consecutive occurrences being greater than the predetermined threshold: monitoring to receive the periodic downlink reference signal from a second beam; terminating the monitoring for the reception of the downlink reference signal from at least the first beam for a time period; or a combination thereof.

In certain embodiments, the reception of the periodic downlink reference signal from at least the first beam comprises reception of the downlink reference signal from the first beam using a single periodic reference signal resource.

In some embodiments, the method further comprises receiving configuration information to indicate a switching pattern for a spatial filter configuration before detecting the number of consecutive occurrences.

In various embodiments, in response to the number of consecutive occurrences being greater than the predetermined threshold, monitoring to receive the periodic downlink reference signal from the second beam, terminating the monitoring for the reception of the downlink reference signal from at least the first beam for the time period, or the combination thereof without receiving additional configuration information.

In one embodiment, the method further comprises incrementing a counter to track the number of consecutive occurrences.

In certain embodiments, incrementing the counter comprises incrementing a separate counter for each periodic reference signal resource, for each beam, or a combination thereof.

In some embodiments, the method further comprises resetting the separate counter in response to proper transmission on a corresponding periodic reference signal resource, a corresponding beam, or the combination thereof.

In various embodiments, the method further comprises resetting the separate counter in response to the separate counter reaching the predetermined threshold and a resulting action being performed.

In one embodiment, the method further comprises receiving information indicating a value of a counter.

In certain embodiments, the information indicating the value of the counter is scrambled.

In some embodiments, the predetermined threshold corresponds to a single periodic reference signal resource or a single beam.

In various embodiments, the predetermined threshold corresponds to all periodic reference signal resources, all beams, or a combination thereof.

In one embodiment, the first beam is quasi-co-located with the second beam.

In certain embodiments, the reception of the downlink reference signal on at least the first beam comprises reception of the downlink reference signal on a plurality of beams, and reception on the plurality of beams is offset in time from each other.

In some embodiments, terminating the monitoring for the reception of the downlink reference signal from at least the first beam for the time period comprises terminating the monitoring for the reception of the downlink reference signal from at least the first beam for the time period without receiving an indication.

In various embodiments, terminating the monitoring for the reception of the downlink reference signal from at least the first beam for the time period comprises receiving an indication, and the indication indicates that the reception of the downlink reference signal from at least the first beam is inhibited for the time period.

In one embodiment, an apparatus comprises a device. The apparatus further comprises: a processor that: detects, for reception of a periodic downlink reference signal from at least a first beam, a number of consecutive occurrences of: an interference level being greater than an interference level threshold; a listen-before-talk failure; or a combination thereof; determines whether the number of consecutive occurrences is greater than a predetermined threshold; and, in response to the number of consecutive occurrences being greater than the predetermined threshold:

monitors to receive the periodic downlink reference signal from a second beam; terminates the monitoring for the reception of the downlink reference signal from at least the first beam for a time period; or a combination thereof.

In certain embodiments, the reception of the periodic downlink reference signal from at least the first beam comprises reception of the downlink reference signal from the first beam using a single periodic reference signal resource.

In some embodiments, the apparatus further comprises a receiver that receives configuration information to indicate a switching pattern for a spatial filter configuration before detecting the number of consecutive occurrences.

In various embodiments, in response to the number of consecutive occurrences being greater than the predetermined threshold, the processor monitors to receive the periodic downlink reference signal from the second beam, terminates the monitoring for the reception of the downlink reference signal from at least the first beam for the time period, or the combination thereof without receiving additional configuration information.

In one embodiment, the processor increments a counter to track the number of consecutive occurrences.

In certain embodiments, the processor incrementing the counter comprises the processor incrementing a separate counter for each periodic reference signal resource, for each beam, or a combination thereof.

In some embodiments, the processor resets the separate counter in response to proper transmission on a corresponding periodic reference signal resource, a corresponding beam, or the combination thereof.

In various embodiments, the processor resets the separate counter in response to the separate counter reaching the predetermined threshold and a resulting action being performed.

In one embodiment, the apparatus further comprises a receiver that receives information indicating a value of a counter.

In certain embodiments, the information indicating the value of the counter is scrambled.

In some embodiments, the predetermined threshold corresponds to a single periodic reference signal resource or a single beam.

In various embodiments, the predetermined threshold corresponds to all periodic reference signal resources, all beams, or a combination thereof.

In one embodiment, the first beam is quasi-co-located with the second beam.

In certain embodiments, the reception of the downlink reference signal on at least the first beam comprises reception of the downlink reference signal on a plurality of beams, and reception on the plurality of beams is offset in time from each other.

In some embodiments, the processor terminating the monitoring for the reception of the downlink reference signal from at least the first beam for the time period comprises the processor terminating the monitoring for the reception of the downlink reference signal from at least the first beam for the time period without receiving an indication.

In various embodiments, the apparatus further comprises a receiver, wherein the processor terminating the monitoring for the reception of the downlink reference signal from at least the first beam for the time period comprises the receiver receiving an indication, and the indication indicates that the reception of the downlink reference signal from at least the first beam is inhibited for the time period.

In one embodiment, a method of a base station comprises: detecting, for transmission of a downlink reference signal from at least a first beam, a number of consecutive occurrences of: an interference level being greater than an interference level threshold; a listen-before-talk failure; or a combination thereof; determining whether the number of consecutive occurrences is greater than a predetermined threshold; and in response to the number of consecutive occurrences being greater than the predetermined threshold: transmitting the downlink reference signal from a second beam; inhibiting transmission of the downlink reference signal from at least the first beam for a time period; or a combination thereof.

In certain embodiments, the transmission of the downlink reference signal from at least the first beam comprises transmission of the downlink reference signal from the first beam using a single periodic reference signal resource.

In some embodiments, the method further comprises transmitting configuration information to a user equipment to indicate a switching pattern for a spatial filter configuration before detecting the number of consecutive occurrences.

In various embodiments, in response to the number of consecutive occurrences being greater than the predetermined threshold, the downlink reference signal is transmitted from the second beam, the downlink reference signal is inhibited from being transmitted from at least the first beam for the time period, or the combination thereof without transmitting additional configuration information to a user equipment.

In one embodiment, the method further comprises incrementing a counter to track the number of consecutive occurrences.

In certain embodiments, incrementing the counter comprises incrementing a separate counter for each periodic reference signal resource, for each beam, or a combination thereof.

In some embodiments, the method further comprises resetting the separate counter in response to proper transmission on a corresponding periodic reference signal resource, a corresponding beam, or the combination thereof.

In various embodiments, the method further comprises resetting the separate counter in response to the separate counter reaching the predetermined threshold and a resulting action being performed.

In one embodiment, the method further comprises transmitting information indicating a value of the counter to a user equipment.

In certain embodiments, the information indicating the value of the counter is scrambled.

In some embodiments, the predetermined threshold corresponds to a single periodic reference signal resource or a single beam.

In various embodiments, the predetermined threshold corresponds to all periodic reference signal resources, all beams, or a combination thereof.

In one embodiment, the first beam is quasi-co-located with the second beam.

In certain embodiments, the transmission of the downlink reference signal from at least the first beam comprises transmission of the downlink reference signal from a plurality of beams, and transmission from the plurality of beams are offset in time from each other.

In some embodiments, inhibiting the transmission of the downlink reference signal from at least the first beam for the time period comprises inhibiting the transmission of the downlink reference signal from at least the first beam for the time period without sending an indication to a user equipment.

In various embodiments, inhibiting the transmission of the downlink reference signal from at least the first beam for the time period comprises transmitting an indication to a user equipment, and the indication indicates that the transmission of the downlink reference signal from at least the first beam is inhibited for the time period.

In one embodiment, an apparatus comprises a base station. The apparatus further comprises: a processor that: detects, for transmission of a downlink reference signal from at least a first beam, a number of consecutive occurrences of: an interference level being greater than an interference level threshold; a listen-before-talk failure; or a combination thereof; and determines whether the number of consecutive occurrences is greater than a predetermined threshold; and a transmitter that, in response to the number of consecutive occurrences being greater than the predetermined threshold: transmits the downlink reference signal from a second beam; inhibits transmission of the downlink reference signal from at least the first beam for a time period; or a combination thereof.

In certain embodiments, the transmission of the downlink reference signal from at least the first beam comprises transmission of the downlink reference signal from the first beam using a single periodic reference signal resource.

In some embodiments, the transmitter transmits configuration information to a user equipment to indicate a switching pattern for a spatial filter configuration before detecting the number of consecutive occurrences.

In various embodiments, in response to the number of consecutive occurrences being greater than the predetermined threshold, the downlink reference signal is transmitted from the second beam, the downlink reference signal is inhibited from being transmitted from at least the first beam for the time period, or the combination thereof without transmitting additional configuration information to a user equipment.

In one embodiment, the processor increments a counter to track the number of consecutive occurrences.

In certain embodiments, the processor incrementing the counter comprises the processor incrementing a separate counter for each periodic reference signal resource, for each beam, or a combination thereof.

In some embodiments, the processor resets the separate counter in response to proper transmission on a corresponding periodic reference signal resource, a corresponding beam, or the combination thereof.

In various embodiments, the processor resets the separate counter in response to the separate counter reaching the predetermined threshold and a resulting action being performed.

In one embodiment, the transmitter transmits information indicating a value of the counter to a user equipment.

In certain embodiments, the information indicating the value of the counter is scrambled.

In some embodiments, the predetermined threshold corresponds to a single periodic reference signal resource or a single beam.

In various embodiments, the predetermined threshold corresponds to all periodic reference signal resources, all beams, or a combination thereof.

In one embodiment, the first beam is quasi-co-located with the second beam.

In certain embodiments, the transmission of the downlink reference signal from at least the first beam comprises transmission of the downlink reference signal from a plurality of beams, and transmission from the plurality of beams are offset in time from each other.

In some embodiments, inhibiting the transmission of the downlink reference signal from at least the first beam for the time period comprises inhibiting the transmission of the downlink reference signal from at least the first beam for the time period without sending an indication to a user equipment.

In various embodiments, inhibiting the transmission of the downlink reference signal from at least the first beam for the time period comprises transmitting an indication to a user equipment, and the indication indicates that the transmission of the downlink reference signal from at least the first beam is inhibited for the time period.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a device, the method comprising:
detecting, for reception of a periodic downlink reference signal from at least a first beam, a number of consecutive occurrences of:
an interference level being greater than an interference level threshold;
a listen-before-talk failure; or
a combination thereof;
determining whether the number of consecutive occurrences is greater than a threshold; and
in response to the number of consecutive occurrences being greater than the threshold:
monitoring to receive the periodic downlink reference signal from a second beam;
terminating the monitoring for the reception of the downlink reference signal from at least the first beam for a time period; or
a combination thereof.

2. The method of claim 1, further comprising receiving periodic downlink reference signal resource configuration information to indicate at least two beams and a switching pattern for the indicated beams before detecting the number of consecutive occurrences.

3. The method of claim 1, wherein, in response to the number of consecutive occurrences being greater than the threshold, monitoring to receive the periodic downlink reference signal from the second beam, terminating the monitoring for the reception of the downlink reference signal from at least the first beam for the time period, or the combination thereof without receiving additional configuration information.

4. The method of claim 1, further comprising incrementing a counter to track the number of consecutive occurrences, wherein incrementing the counter comprises incrementing a separate counter for each periodic reference signal resource, for each beam, incrementing a single counter for the periodic reference signal resource set, or a combination thereof.

5. The method of claim 4, further comprising resetting the separate counter in response to proper transmission on a corresponding periodic reference signal resource, a corresponding beam, or the combination thereof.

6. The method of claim 4, further comprising resetting the separate counter in response to the separate counter reaching the threshold and a resulting action being performed.

7. The method of claim 1, wherein the threshold corresponds to a single periodic reference signal resource or a single beam.

8. The method of claim 1, wherein the threshold corresponds to all periodic reference signal resources, all beams, or a combination thereof.

9. The method of claim 1, wherein the reception of the downlink reference signal on at least the first beam comprises reception of the downlink reference signal on a plurality of beams, and reception on the plurality of beams is offset in time from each other.

10. The method of claim 1, wherein terminating the monitoring for the reception of the downlink reference signal from at least the first beam for the time period comprises terminating the monitoring for the reception of the downlink reference signal from at least the first beam for the time period without receiving an indication.

11. The method of claim 1, wherein terminating the monitoring for the reception of the downlink reference signal from at least the first beam for the time period comprises receiving an indication, and the indication indicates that the reception of the downlink reference signal from at least the first beam is inhibited for the time period.

12. An apparatus comprising:
a processor; and
a memory coupled to the processor, the memory comprising instructions executable by the processor to cause the apparatus to:
detect, for reception of a periodic downlink reference signal from at least a first beam, a number of consecutive occurrences of:
an interference level being greater than an interference level threshold;
a listen-before-talk failure; or
a combination thereof;
determine whether the number of consecutive occurrences is greater than a threshold; and
in response to the number of consecutive occurrences being greater than the threshold:
monitor to receive the periodic downlink reference signal from a second beam;
terminate the monitoring for the reception of the downlink reference signal from at least the first beam for a time period; or
a combination thereof.

13. The apparatus of claim 12, wherein the instructions are further executable by the processor to cause the apparatus to receive periodic downlink reference signal resource configuration information to indicate at least two beams and a switching pattern for the indicated beams before detecting the number of consecutive occurrences.

14. The apparatus of claim 12, wherein, in response to the number of consecutive occurrences being greater than the threshold, the instructions are further executable by the processor to cause the apparatus to monitor to receive the periodic downlink reference signal from the second beam, terminate the monitoring for the reception of the downlink reference signal from at least the first beam for the time period, or the combination thereof without receiving additional configuration information.

15. An apparatus comprising:
a processor; and
a memory coupled to the processor, the memory comprising instructions executable by the processor to cause the apparatus to:
detect, for transmission of a downlink reference signal from at least a first beam, a number of consecutive occurrences of:
an interference level being greater than an interference level threshold;
a listen-before-talk failure; or
a combination thereof; and
determine whether the number of consecutive occurrences is greater than a threshold; and
in response to the number of consecutive occurrences being greater than the threshold:
transmit the downlink reference signal from a second beam;
inhibit transmission of the downlink reference signal from at least the first beam for a time period; or
a combination thereof.

16. The apparatus of claim 15, wherein the transmission of the downlink reference signal from at least the first beam comprises transmission of the downlink reference signal from the first beam using a single periodic reference signal resource.

17. The apparatus of claim 15, wherein the instructions are further executable by the processor to cause the apparatus to transmit configuration information to a user equipment to indicate a switching pattern for a spatial filter configuration before detecting the number of consecutive occurrences.

18. The apparatus of claim 15, wherein, in response to the number of consecutive occurrences being greater than the threshold, the downlink reference signal is transmitted from the second beam, the downlink reference signal is inhibited from being transmitted from at least the first beam for the time period, or the combination thereof without transmitting additional configuration information to a user equipment.

19. The apparatus of claim 15, wherein the instructions are further executable by the processor to cause the apparatus to increment a counter to track the number of consecutive occurrences.

20. The apparatus of claim 15, wherein the instructions are further executable by the processor to cause the apparatus to increment a separate counter for each periodic reference signal resource, for each beam, or a combination thereof.
